(19) United States
(12) Patent Application Publication
(10) Pub. No.: US 2006/0036440 A1
(43) Pub. Date: Feb. 16, 2006

(54) Biowaves technology

(76) Inventor: Daniel Kunkel, Bellevue, WA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/201,446

(22) Filed: Aug. 10, 2005

Related U.S. Application Data
(60) Provisional application No. 60/600,430, filed on Aug. 10, 2004.

(51) Int. Cl. G10L 11/00

(52) U.S. Cl. 704/270

(57) ABSTRACT

A system for analyzing a voice for a physical condition or deficiency comprising a system for inputting a voice into a system and transmitting it to a server; means for generating a graph of the voice; software means for determining an anomaly points in the graph; and means for characterizing the anomaly and comparing it to known data related to a health condition or chemical imbalance.

### CROSS-REFERENCES TO RELATED APPLICATIONS

This application claims benefit to provisional application 60/600,430, filed on Aug. 10, 2004, entitled “Biowaves Technology,” which is incorporated by reference herein in its entirety.

### FIELD OF THE INVENTION

The present invention is directed to a system for remotely recording the human voice, converting voice recording to digital output, and transmitting the vocal information to a remote processing site for analysis, to determine the physical health of an individual. In particular, the present invention is directed to a remote system in which vitamin deficiencies and/or high levels of dangerous chemicals or substances, such as lead, can be determined based upon anomalies in the voice pattern. The present invention covers transmitting the vocal information in any form to a remote location via any means including: Internet transmission, satellite transmission, phone line transmission.

### BACKGROUND OF THE INVENTION

The present invention is directed to systems for facilitating the use of the human voice to determine physical and medical well-being. It has long been believed that changes in the voice structure are symptomatic of more serious medical issues.

A number of technologies have been developed which address the question of voice stress as it relates to mental or physiological state. U.S. Pat. No. 6,523,008 dated Feb. 18, 2003 to Avrunin discloses a method for truth-enabling communications over a computer network using computer voice stress analysis. A sender creates a text message at a first computer of the computer network. The sender also enters into the first computer speech input indicating the veracity of the text message. For example, the speech input may indicate the veracity of the text message through an explicit assertion that the sender believes the text message to be truthful. By applying computer voice stress analysis to the speech input, a computer voice stress analysis program determines the veracity of the text message. The text message and an indication of the veracity of the text message may both be sent over the computer network to a recipient.

U.S. Pat. No. 6,363,346 dated Mar. 26, 2002 to Walters discloses a telephone call reception system which infers mental and/or physiological states of the callers. Two types of analysis are available, and both types may be used upon the telephone calls. In one type, speech recognition is performed upon the call to generate a text file. Key words are sought in the text file. In the second type, the electrical signal itself is processed, as by a spectral analysis. Information obtained by the two analyses is used to predict the mental or physiological state of the caller.

U.S. Pat. No. 6,151,571 dated Nov. 21, 2000 to Pertrushin discloses a method and system for monitoring a conversation between a pair of speakers for detecting an emotion of at least one of the speakers is provided. First, a voice signal is received after which a particular feature is extracted from the voice signal. Next, an emotion associated with the voice signal is determined based on the extracted feature. The emotion is screened and feedback is provided only if the emotion is determined to be a negative emotion selected from the group of negative emotions consisting of anger, sadness, and fear. Such determined negative emotion is then outputted to a third party during the conversation.

U.S. Pat. No. 6,055,501 dated Apr. 25, 2000 to MacCaughelty discloses a method and apparatus for detecting counter homeostasis oscillation perturbation signals (CHOPS) found within the wave form of human speech that reflects either arousal in the autonomic nervous system or other biological processes. The apparatus is a speech analysis system for obtaining biofeedback information from human speech samples having variable duration. The speech analysis system comprises means for digitizing the human speech samples, storage means for receiving the digitized speech samples from the digitizing means and storing the digitized speech samples, processing means for detecting and analyzing CHOPS in the digitized speech samples and display means for presenting the analyzed speech samples in a visual representation. The speech analysis system may further include transducer means for collecting and transducing human speech samples into electrical signals and input means for configuring the analysis parameters of the processing means. The present invention does not require any electrode or probe attachment from the speech analysis system to a subject. The method provides biofeedback from physiological indicators of stress using the speech analysis system. The method includes recording a human speech sample having variable duration with the transducer means, digitizing the human speech sample with the means for digitizing, storing the digitized speech sample in the storage means, determining CHOPS in the digitized speech sample with the processing means based on pre-determined parameters and identifying relationships between the CHOPS in the digitized speech sample with the processing means.

None of the prior art patents disclose a system for analyzing voice patterns and for identifying physical symptoms or attributes, such as health conditions, vitamin deficiencies and the existence of dangerous substances.

It is an object of the present invention to provide a system for analyzing voice patterns and for determining a physical ailment or condition such as a vitamin deficiency or disease condition.

It is further object of the present invention to provide a system which facilitates the online recording and analysis of a voice for a vitamin deficiency.

It is a further object of the invention to provide a system that enables individuals to diagnose or identify a physical malady.

It is a further object of the present invention to provide a system that permits the analysis of the voice for analogies representing vitamin deficiencies and the like.

### BRIEF DESCRIPTION OF THE DRAWINGS

FIG. 1 is a block diagram of a system for use in the present invention.

FIG. 2 is a more detailed diagram of the present invention.

FIG. 3 is a block diagram of the database system of the present invention.

FIG. 4 is a block diagram of the voice frequency output of the present invention.

FIG. 5 is a diagram of the charts illustrating a correlation of vitamin deficiencies and voice frequency analogies.

FIGS. 6 to 8a are other user screens in accordance with the present invention.

### DETAILED DESCRIPTION OF THE INVENTION

The present invention is described with reference to the enclosed Figures wherein the same numbers are utilized where applicable. The present invention is directed to a system for capturing the human voice and for determining related biological factors. It has been hypothesized that differences in voice characteristics are linked to vitamin deficiencies or the presence of a certain substance such as mercury or lead and that an analysis of vocal characteristics can establish these conditions.

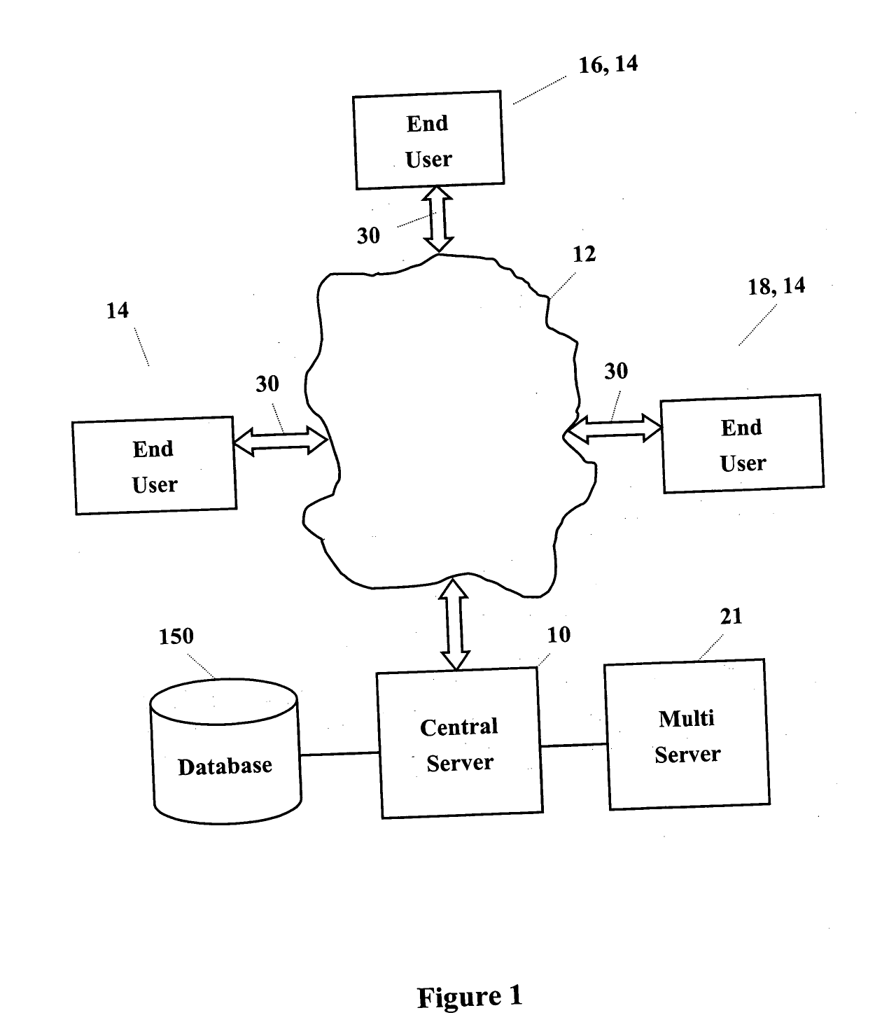

Referring to FIG. 1, a most preferred embodiment of the present invention is disclosed and shown. The most preferred embodiment comprises a central computer server 10 connected by a computer network 12 to remote end user stations 14. The central server connects to a database 150. As will be discussed herein, the database 150 will include data related to physical conditions, vitamin deficiency characteristics, chemical imbalances or the existence of hazardous substances in the body such as lead or mercury. As will be discussed herein, the database 150 will include the relationship between vocal characteristics and related health conditions, data with a physiological relationship as contained within the body relating health, nutritional and hazardous substance information with frequencies.

In a preferred embodiment, end user stations 14 comprise a plurality of end users 16, 18. End users 16, 18 are defined herein as entities linked to the system who comprise companies and individuals who desire to upload recorded voice samples. Users 16, 18 are linked with the central computer server 10 via a transport medium 30. End users 16, 18 will typically comprise individuals that desire to create, record and upload voice samples. In a most preferred embodiment, will be linked via a global computer network 12 such as the Internet or Worldwide web, but other embodiments including LANs, WANs and Intranets, which fulfill the spirit and scope of the present invention.

The end user devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the end user will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system. Through communication link and transport medium 30, end user customers and end users 16, 18 are linked to the central server 12, preferably by a customizable interface to be described in greater detail below.

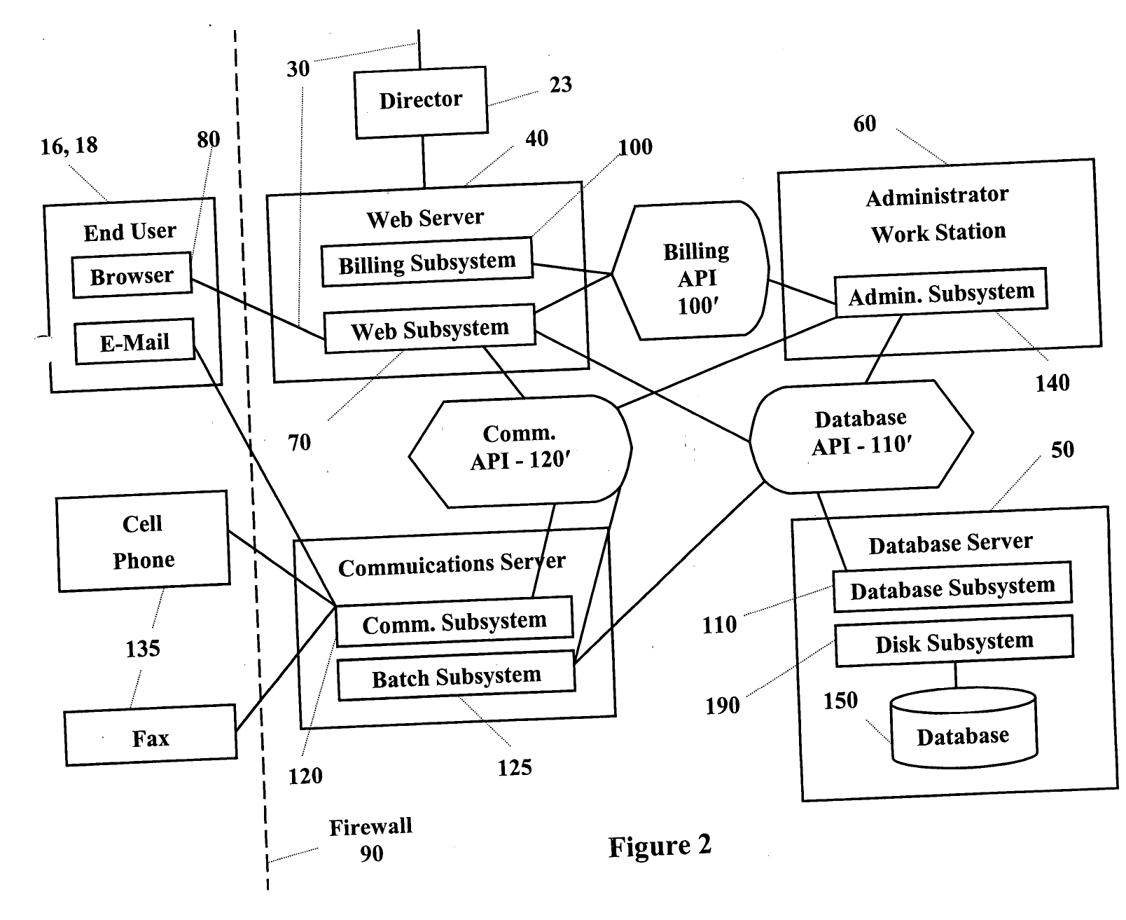

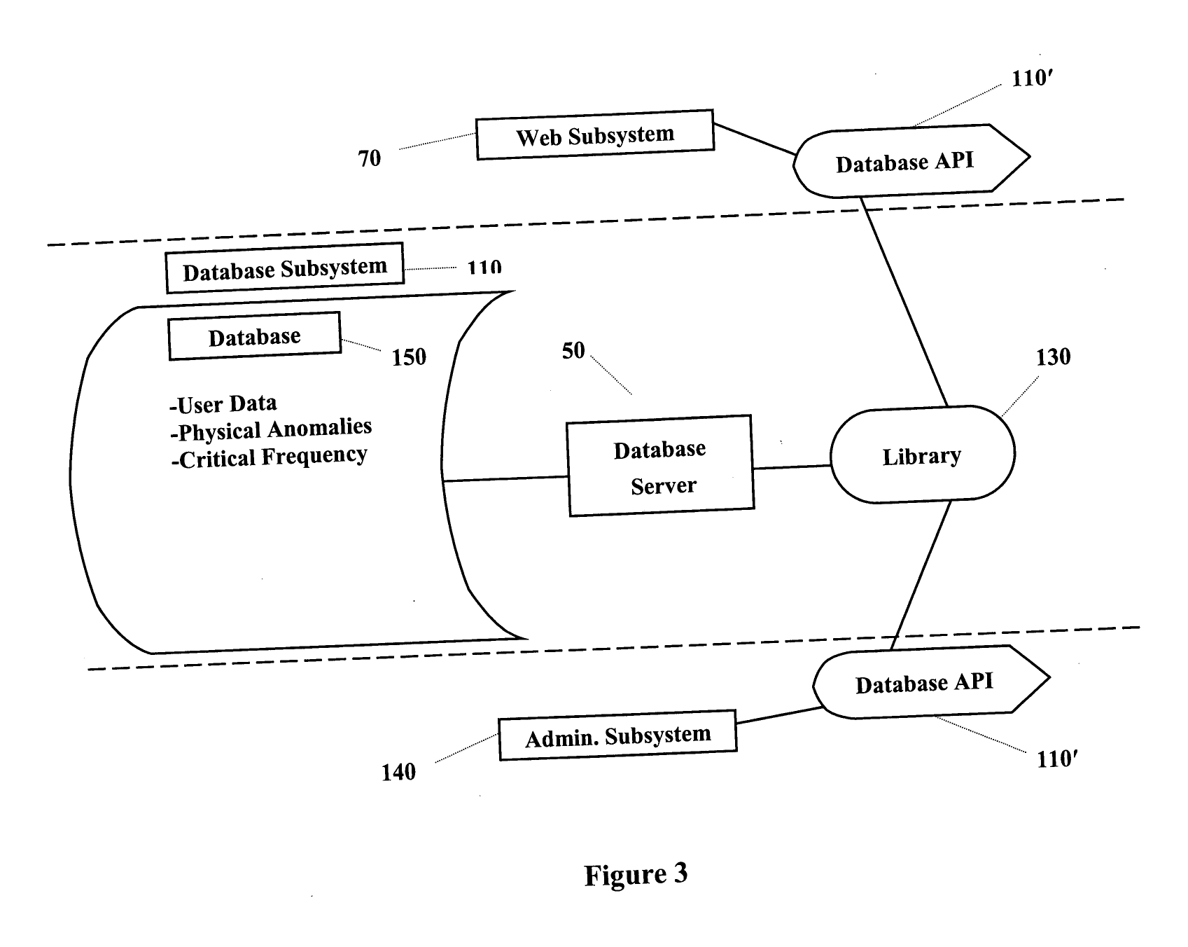

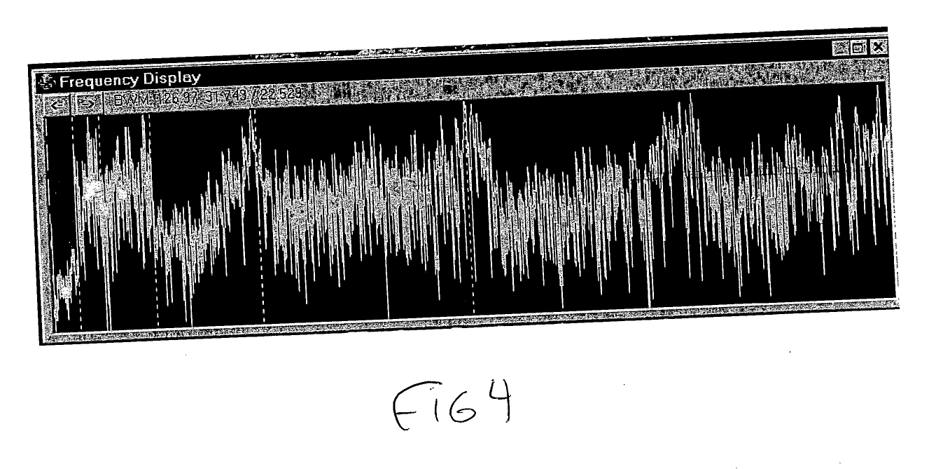

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server or Oracle. The system may operate under other platforms such as ASP and JAVA (e.g. J2EE) Hence, in one embodiment the SQL server may run SQL server database management software from Microsoft Corporation.

Alternatively, the server can further comprise an Oracle database server. The system further includes an administrative work station 60 or system which provides the administrative capabilities and monitoring for the system under the control of an administrative subsystem 140. The administrative work station 60 allows administrators or other operators to perform routine operations which affect the entire system. Such operations include, but are not limited to, administering the accounts of end users 16, 18 monitoring the traffic through the system.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system.

The expression of the user interface presented to end users 16, 18 in their client devices may be implemented as HTML or other high level computer language or technology, and may be displayed in a standard web browser.

All World Wide Web systems listed above are preferably communicated, for example, by an Ethernet 100 base T network and a switching hub. In addition, a second isolated network segment will preferably exist between the web server 40 and the external communications hardware (e.g. internet router). Such a system will keep external traffic isolated from the internal network, as well as provide a dedicated connection between the web server 40 and the Internet for maximum throughput. The systems will have an initial configuration of random access memory for the web server 40 and preferably at least 128 megabits for the database server 50, both having the capability to expand.

The web server 40 may be a point of entry to the entire system. The system determines the identity of the user 16, 18 and makes appropriate decisions while serving web pages to the end user 16, 18. The web server 40 sends HTML, XML, JAVA, or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment. The server typically includes IIS, which is a completely integrated Internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment. It is to be appreciated that the invention envisions new and expanding technologies.

The operators of the central system may create, delete and update account information by utilizing the administrative subsystem 140 in administration work station 60. A billing subsystem 100 is used for crediting and debiting end user accounts.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database. As will be discussed below, firewall 90 plays an important and critical role in the present invention because of the confidentiality of the data associated with some applications of the present invention.

In a preferred embodiment, the database subsystem 110 stores all pertinent information related to user accounts, administrator accounts, payments and messages, as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18. End users 16, 18 may be notified by phone, fax, email or pager, or other communications devices which can be contacted by the system 135. End users 16, 18 will also have a password accessed section in which they can review uploaded voice patterns and the like.

A batch subsystem 125 may periodically send out grouped notifications. It will access the database subsystem 110 to determine what notifications are required, and uses the communication subsystem 120 to make those notifications. A group notification may comprise a special premium offered to end users 16, 18. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs information regarding the end user, his voice patterns, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

With the above as a background for the present analysis, the present invention is now described. The present invention comprises a system for analyzing the human voice. In a most preferred embodiment, the system comprises an online system whereby individuals can record a voice sample and then transmit it to the remote server. The server is under the control of a computer program which will analyze the voice pattern and identify an attribute or an anomaly regarding the user's voice.

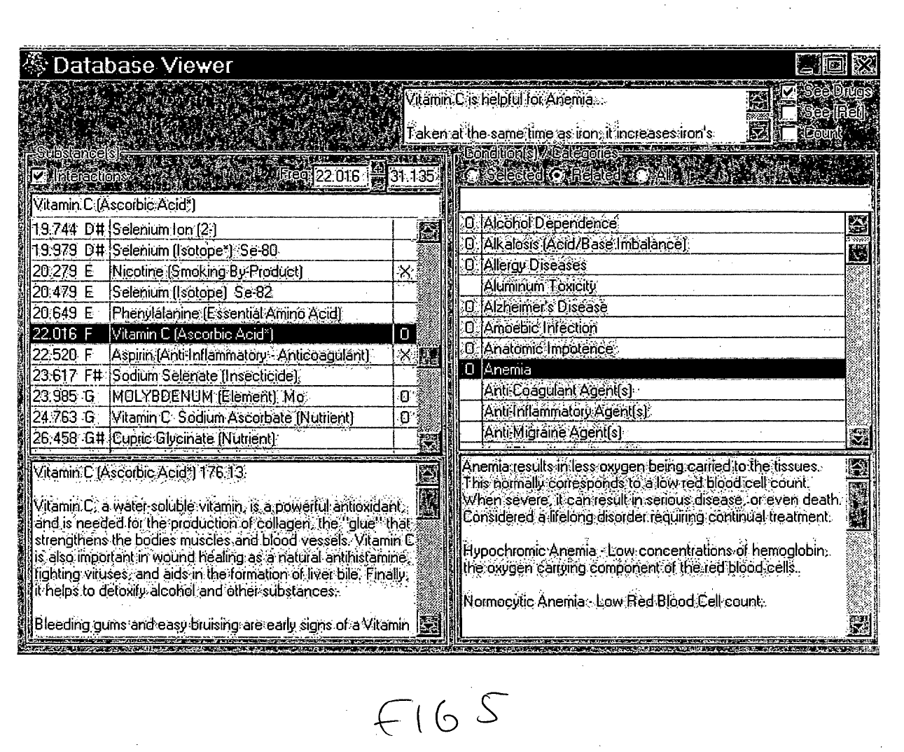

The system initially includes a system for inputting the user's voice. The voice may be entered via a microphone at user stations 16, 18 and then sent as a WAV or MP3 file, to the remote host 21. At the remote host station, the voice is plotted via software as shown in FIG. 4. The system identifies frequency spikes. The system zooms in on the large spikes. Each spike represents a voice frequency anomaly.

The frequencies are plotted. The overview display shown to the end user allows a single octave or all of the octaves together. Each anomaly frequency spike can then be compared to a known characteristic which is a vitamin deficiency or the existence of a dangerous chemical such as lead or mercury.

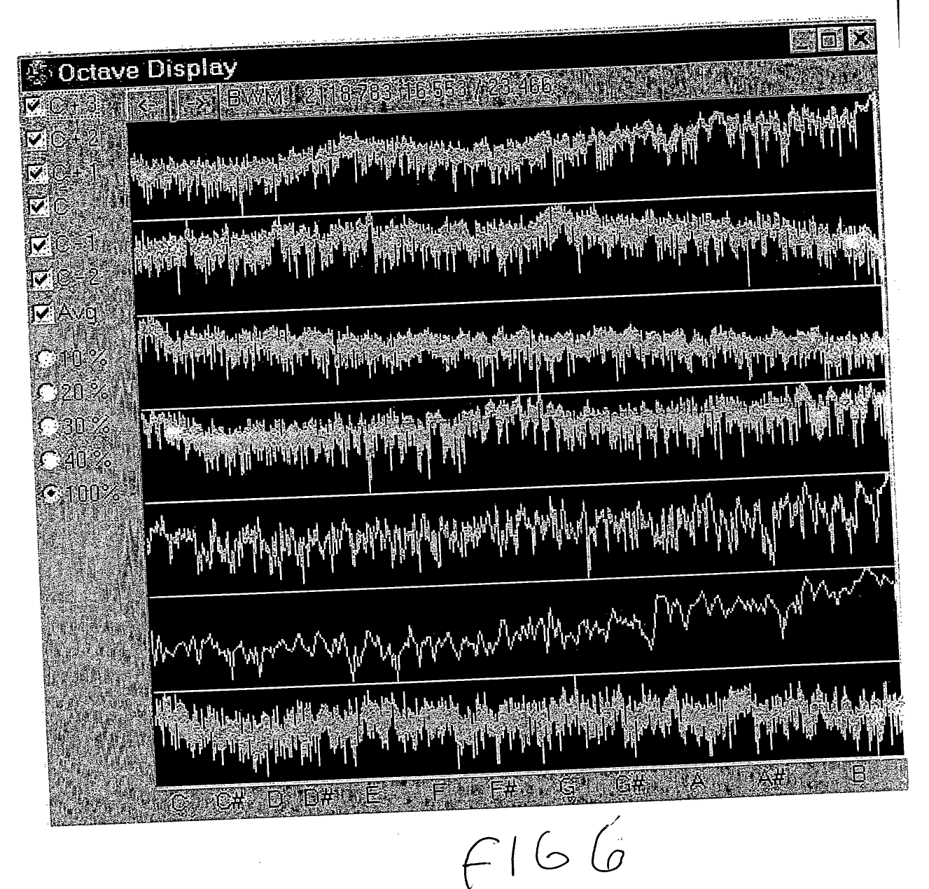

Referring to FIGS. 4 and 5, the operation of the system enables a system to identify vitamin deficiencies. When the critical frequency identifies the base frequencies related to vitamin or chemical substances, the anomalous frequency may be a multiple of the base frequency. As seen, a large number of vitamins and minerals are shown. In addition to all of the above features, the fact that the database is integrated with the other windows makes searching for a frequency extremely easy. When a frequency is highlighted, it will be automatically searched for and displayed in the database viewer along with other substances within a range of 0.015 hz. Conditions relating to any of the substances are also displayed in the box labeled conditions/categories.

If the analysis is at 22.018 hertz and the software cannot find any substances at 22.018. It looks up 22.016 in the database and finds that this is the frequency for Vitamin C. Vitamin C is very biologically active and is involved in many process of the body.

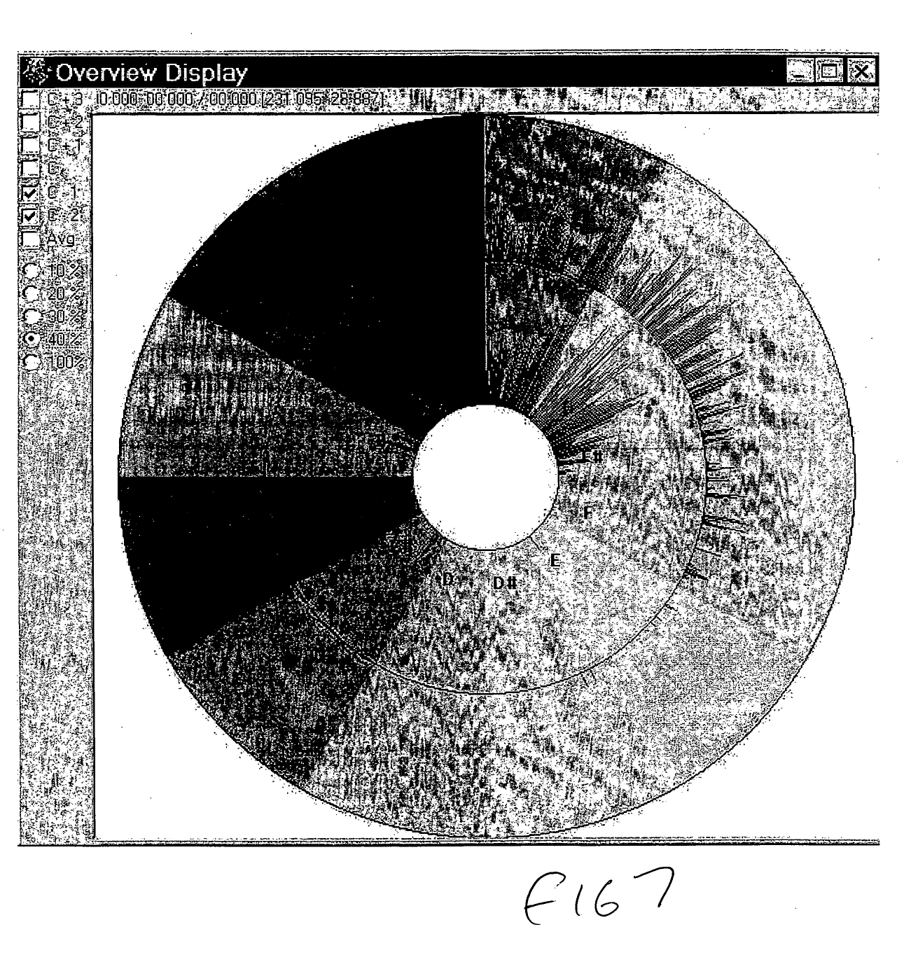

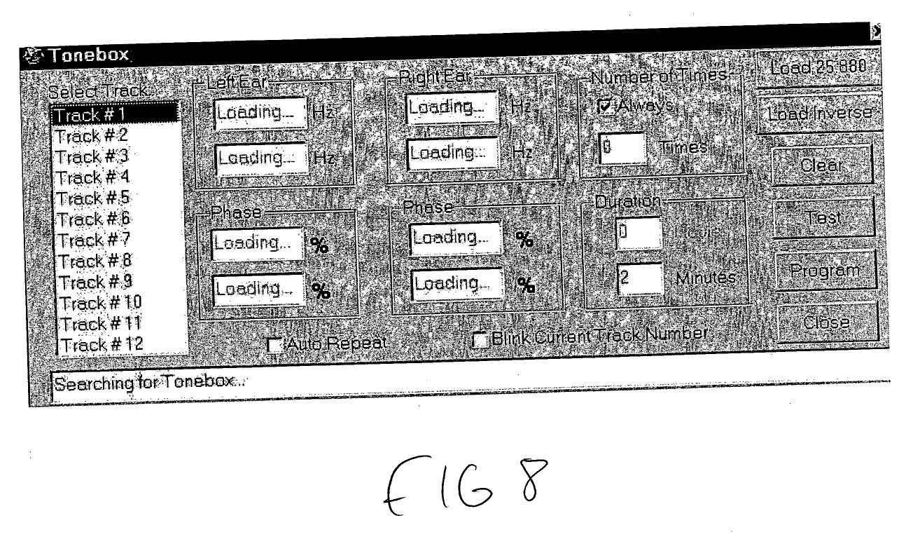

The system provides information on this vitamin. To find the foods which have a high Vitamin C content, “Food Nutritional Sources” are located in the Conditions box. A box in the upper right corner will appear. A list will appear that is updated as to help locate whatever the user is looking for. When you see it you can simply click on it and the database will display the information. Alternatively, Vitamin C in the list of substances in the substance window we could have simply double clicked on it to look it up. Double clicking will also work with Conditions or Categories you see in the condition/category list. This portion of the site will include nutritional information for the endorser. FIG. 6 illustrates a user screen which lays out time data, frequency and harmonies. FIG. 7 illustrates a color wheel used to identify frequency anomalies.

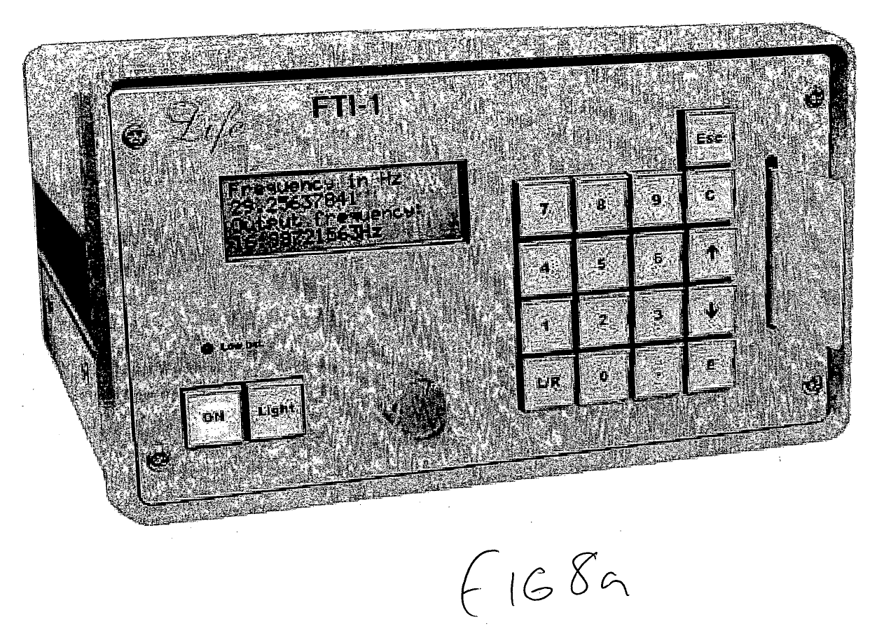

In other embodiments, the invention can be used to play harmonic sounds or music to affect health or user well-being. FIGS. 8 and 8a illustrates a multiple track tone box application for this purpose.

The present invention has been described with reference to the above-discussed preferred embodiment. It is to be appreciated that the present invention has a number of embodiments but the true nature and scope of the invention is to be determined with reference to the claims appended hereto.

1. A system for remotely analyzing a voice for a physical condition or deficiencies comprising
a system for inputting a voice into a system and transmitting it to a server;
means for generating a graph of the voice;
software means for determining an anomaly points in the graph, identifying characteristic patterns in the data;
means for characterizing the anomaly and comparing it to known data related to a chemical problem or vitamin deficiency.

2. The condition or deficiency further means to provide information related to the relevant chemical problem or vitamin deficiency.

3. A system for analyzing a voice for a vitamin deficiency
a system for inputting a voice into a system and transmitting it to a server;
means in communication for generating a graph of the voice;
software means for determining an anomaly points in the graph; and
means for characterizing the anomaly and comparing it to known data related to a chemical problem or vitamin deficiency.
